(19) United States
(12) Patent Application Publication
(10) Pub. No.: US 2010/0070642 A1
(43) Pub. Date: Mar. 18, 2010

(54) OFFLOADING NETWORK PROTOCOL OPERATIONS TO NETWORK INTERFACE IN SLEEP STATE

(75) Inventors: Deepak Bansal, Redmond, WA (US); Katarzyna A. Puchala, Redmond, WA (US); Murari Sridharan, Sammamish, WA (US); Narasimhan A. Venkataramaiah, Redmond, WA (US); Gurpreet Virdi, Bellevue, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 12/210,739

(22) Filed: Sep. 15, 2008

(51) Int. Cl. G06F 15/16

(52) U.S. Cl. 709/230

(57) ABSTRACT

A computing device participates in network protocol operations when the computing device is in an inactive state. A main processor of the computing device transfers protocol mode instructions and data corresponding to a selected network protocol to a network interface of the computing device, and the network interface executes the protocol mode instructions on behalf of the main processor when the main processor is in the inactive state. The main processor may select a network protocol from two or more network protocols and may download protocol mode instructions and data corresponding the selected network protocol to the network interface. The network interface may compare a received packet to at least one received packet pattern and may respond to the received packet in accordance with a result of the comparison.

### FIELD OF THE INVENTION

This invention relates to operation of a computing device in an inactive state and, more particularly, to enabling a computing device to participate in network protocol operations when the computing device is in the inactive state.

### BACKGROUND OF THE INVENTION

It is known to provide an inactive state, commonly known as a “sleep” state, of a computing device. In the sleep state, non-essential components and subsystems of the computing device are powered down, thereby reducing power consumption. Reducing power consumption is important with any computing device, but is particularly important with battery-operated devices, such as laptop computers and mobile devices. Depending on its configuration, the computing device in the sleep state may not respond to received data packets. The sleep state may be initiated automatically in the absence of user inputs for a predetermined time and may be terminated when the user resumes activity. In practice, a computing device may have more than one sleep state, and more or fewer components may be powered down in each sleep state.

Currently, when a PC (personal computer) enters a sleep state S3, it may lose network presence and may no longer participate in standard networking protocols or advertise its presence on the network. Any other PC trying to reach a computing device in the sleep state must know its physical as well as its IP address, since the computing device may be unavailable to serve resolution requests for its addresses.

This limitation has been addressed in prior systems by providing the network interface card (NIC) with fixed network protocol capabilities. When the PC enters the sleep state, the network interface card acts as a proxy on its behalf to participate in network protocol functions. However, providing the NIC with fixed network protocol capabilities has limitations. First, the limited space and processing power available on the NIC allows for only some protocols, which are selected to match the most common environments. For example, if the NIC can only respond to the address resolution protocol (ARP) and the PC happens to be in the IPv6-only environment, which requires neighbor discovery proxy functionality, then the capabilities of the NIC are useless in enabling Wake-On-LAN. Second, hard coding protocol behaviors into the NIC does not allow for flexibility and individual user control For example, one user may want to enable his PC to respond to very specific, uncommon protocols while asleep, but other users may prefer that their PC is not reachable for these protocols.

Accordingly, there is a need for improved methods and apparatus for enabling a computing device to participate in network protocol operations when the computing device is in an inactive or sleep state.

### SUMMARY OF THE INVENTION

According to a first aspect of the invention, a method is provided to enable a computing device to participate in network protocol operations when the computing device is in an inactive state. The method comprises a main processor of the computing device transferring protocol mode instructions and data corresponding to a selected network protocol to a network interface of the computing device, and the network interface executing the protocol mode instructions on behalf of the main processor when the main processor is in the inactive state. The main processor may enable a protocol mode of the network interface when the main processor enters the inactive state and may disable the protocol mode of the network interface when the main processor exits the inactive state.

In some embodiments, the data transferred from the main processor to the network interface may include a received packet pattern that complies with the selected network protocol. The network interface may compare a received packet to the received packet pattern and may respond to the received packet in accordance with a result of the comparison. In farther embodiments, the data transferred from the main processor to the network interface may include a reply packet pattern that complies with the selected network protocol. A reply packet having the reply packet pattern may be sent by the network interface in response to a received packet. The transfer of protocol mode instructions and data from the main processor to the network interface may include selecting a network protocol from two or more network protocols and downloading protocol mode instructions and data corresponding to the selected network protocol.

In additional embodiments, a computer-readable storage medium is encoded with instructions for execution in a computing device, the instructions when executed performing a method as described above to enable the computing device to participate in network protocol operations when the computing device is in an inactive state.

According to a second aspect of the invention, a computing device having an active state and an inactive state is provided. The computing device comprises a main processor including a main processing device and a system memory, the system memory containing protocol mode instructions and data corresponding to at least one network protocol, and a network interface including a network interface processing device and a network interface memory. The main processor is configured to transfer the protocol mode instructions and the data corresponding to a selected network protocol from the system memory to the network interface memory, and the network interface is configured to execute the protocol mode instructions on behalf of the main processor when the main processor is in the inactive state.

### BRIEF DESCRIPTION OF THE DRAWINGS

For a better understanding of the present invention, reference is made to the accompanying drawings, which are incorporated herein by reference in and which:

FIG. 1 is a pictorial representation of a prior art computer system wherein a PC in the sleep state does not respond to an ARP request;

FIG. 2 is a pictorial representation of a computer system in accordance with embodiments of the invention wherein a PC in the sleep state sends a reply to an ARP request;

FIG. 3 is a pictorial representation of a computer system in accordance with embodiments of the invention wherein a PC in the sleep state sends a reply to an ND request;

FIG. 4 is a block diagram generally illustrating an example of a computer system in which the present invention operates;

FIG. 5 is a simplified block diagram of a computing device and illustrates components involved in embodiments of the invention;

FIG. 6 is a flow chart of operations executed by the main processor in accordance with embodiments of the invention; and

FIG. 7 is a flow chart of operations executed by the network interface in accordance with embodiments of the invention.

### DETAILED DESCRIPTION

In accordance with embodiments in the invention, a computing device offloads network protocol operations from a main processor of the computing device to a network interface, such as a network interface card (NIC). When the main processor is in a sleep state, the network interface performs network protocol operations on behalf of the main processor. The offloading of network protocol operations to the network interface is programmable under control of the operating system in the main processor. The network interface can be programmed to perform protocol operations for a single network protocol or for two or more network protocols. The selection of network protocols can be controlled by a user or can be controlled automatically in response to the configuration of the system. The network protocol operations performed by the network interface can be changed from time to time, and network protocols can be added or deleted. Thus, network protocol operations during the sleep state of the computing device are flexible and controllable.

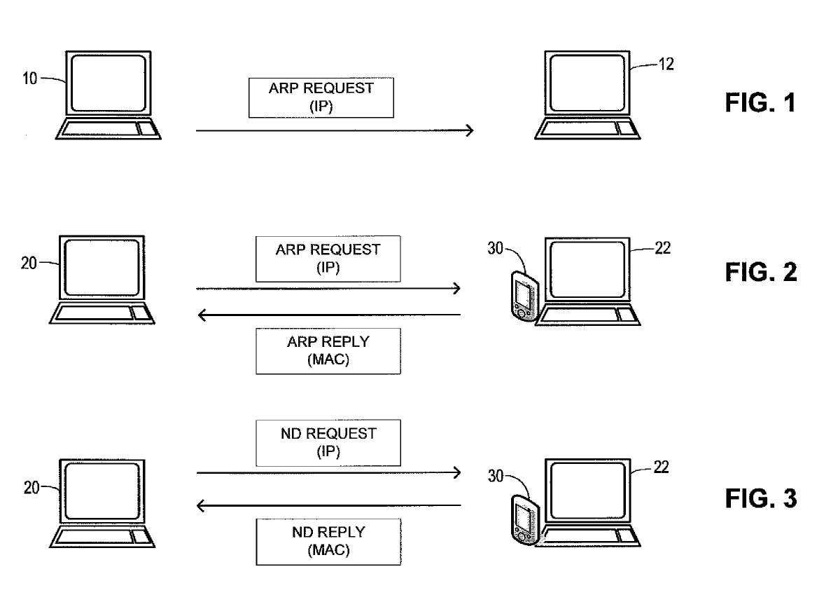

Referring to FIG. 1, a computing device 10 in an active state has a network connection to a prior art computing device 12 in an inactive, or sleep, state. Computing device 10 sends an ARP (address resolution protocol) request to computing device 12. Computing device 12 in the sleep state discards the ARP request and does not send a reply to computing device 10.

Referring to FIG. 2, a computing device 20 has a network connection to a computing device 22 in the sleep state. Computing device 22 includes a network interface 30 and is configured in accordance with embodiments of the invention. The network connection can be a wired connection, a wireless connection, or a combination of wired and wireless connections. Computing device 20 sends an ARP request to computing device 22. The network interface 30 is configured to recognize the ARP request and to respond with an ARP reply on behalf of the main processor, with the main processor of computing device 22 remaining in the sleep state.

Referring to FIG. 3, computing device 20 sends an ND (neighbor discovery) request to computing device 22, while computing device 22 is the sleep state. Network interface sends an ND reply to computing device 20 on behalf of the main processor of computing device 22. In one embodiment, network interface 30 of computing device 22 has been programmed to reply to both ARP requests and ND requests. In another embodiment, network interface 30 is programmed to respond to ARP requests and at a different time is programmed to respond to ND requests.

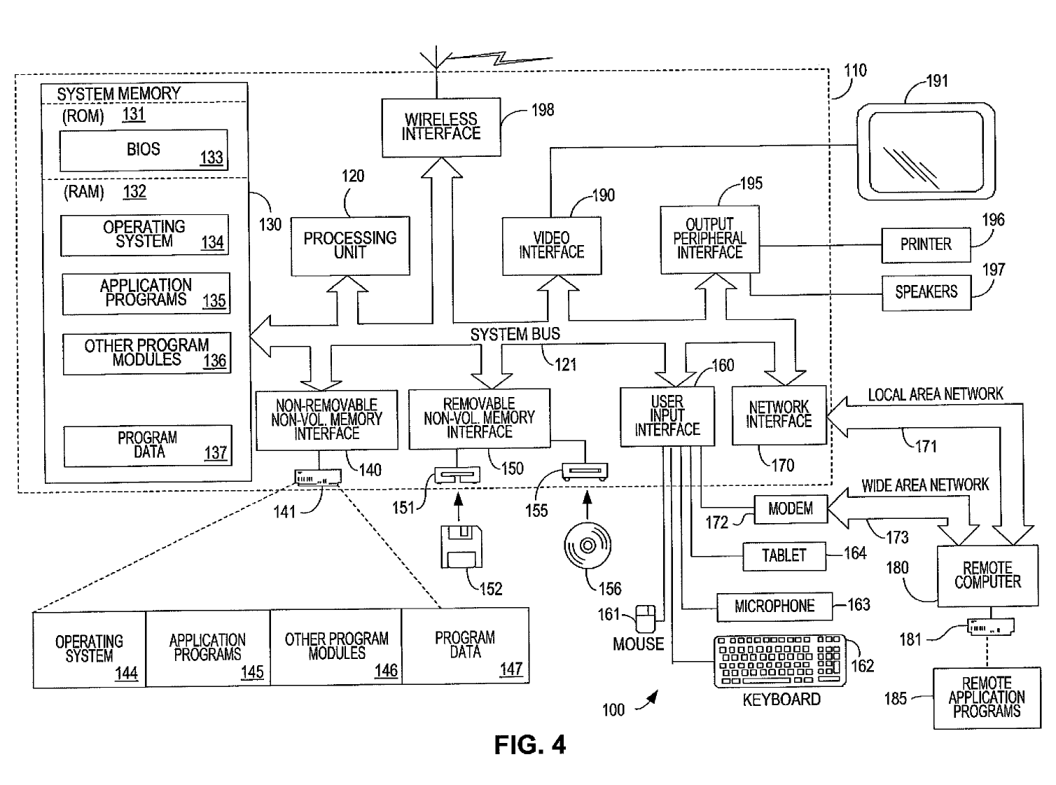

FIG. 4 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 4, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Combinations of the any of the above should also be included within the scope of computer readable storage media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 4 illustrates operating system 134, application programs 135, other program modules 136, and program data 137.

The computer 110 may also include other removable/non-removable, volatile/nonvolatile computer storage media. By way of example only, FIG. 4 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 trough an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 4, provide storage of computer readable instructions, data structures, program modules and other data for the computer 110. In FIG. 4, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 10 through input devices such as a keyboard 162 and pointing device 161, commonly referred to as a mouse, trackball or touch pad. Other input devices may include a microphone 163, joystick, a tablet 164, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through a output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 4. The logical connections depicted in FIG. 4 include a local area network (LAN) 171 and a wide area network (WAN) 173 and a wireless link, for example via a wireless interface 198 complete with an antenna, but may also include other networks. Such networking environments are commonplace in offices, enterprise-wide computer networks, intranets and the Internet. While wireless interface 198 is shown directly connected to system bus 121, it is recognized that the wireless interface 198 may be connected to system bus 121 via network interface 170.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 4 illustrates remote application programs 185 as residing on memory device 181. It will be appreciated that the network connections shown are exemplary and other means of establishing a communications link between the computers may be used.

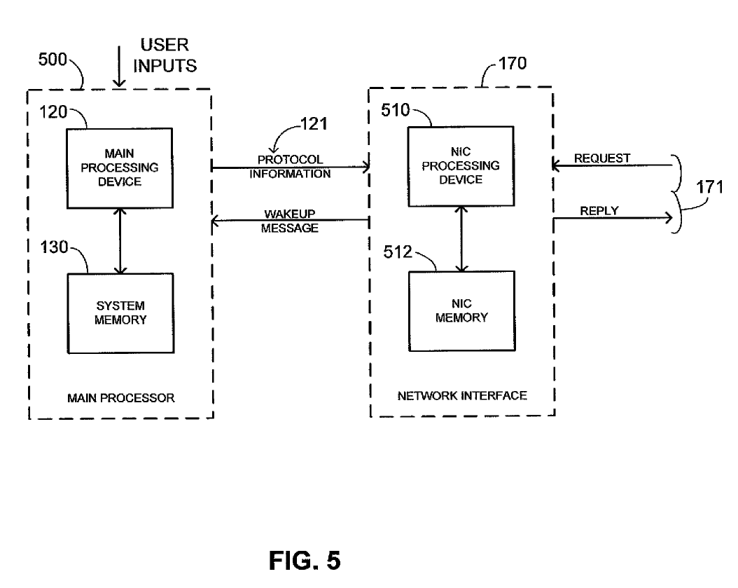

Embodiments of the invention are described with reference to FIGS. 5-7. Components of computer 110 involved in the operation of the invention are shown in FIG. 5. The main processing device 120 and system memory 130 may be considered a main processor 500 of the computing device 110. The network interface 170 includes an NIC processing device 510 and an NIC memory 512. Typically, NIC processing device 510 has less processing power than main processing device 120, and MC memory 512 has a smaller capacity than system memory 130. However, the invention is not limited in this respect.

Main processor 500 and network interface 170 are components of the computing device. As indicated above, main processor 500 has an inactive, or sleep, state where non-essential components of main processor of 500 are powered down. In practice, main processor 500 may have more than one sleep state, triggered by different levels of activity or lack of activity. In the sleep state of main processor 500, network interface 170 remains active, at least to the extent required to perform network protocol operations as described below. As shown, main processor 500 and network interface 170 communicate on system bus 121, and network interface 170 may communicate on local area network 171.

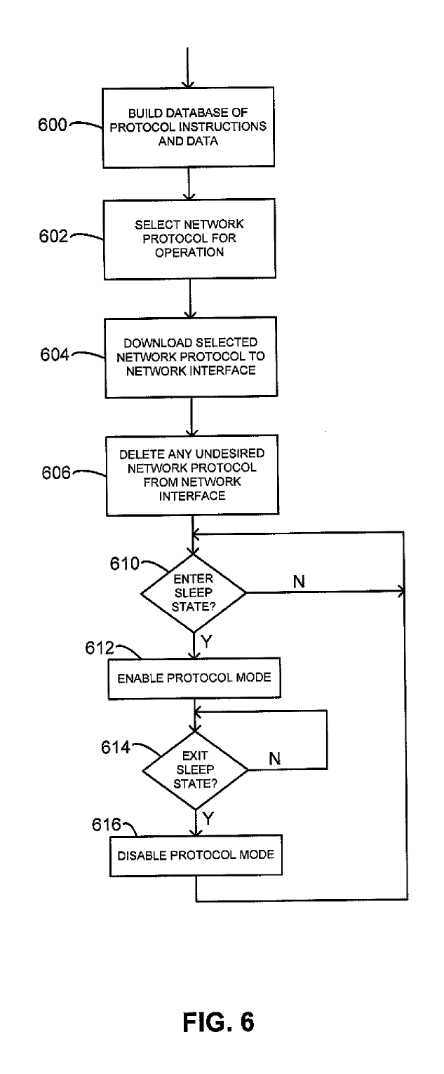

A flow chart of operations performed by main processor 500 in accordance with embodiments of the invention is shown in FIG. 6. In act 600, a database of protocol information is built for one or more network protocols. The protocol information may include protocol mode instructions, data and any other information required by the network interface 170 to perform network protocol operations on behalf of the main processor 500. The protocol information may be stored in system memory 130 (FIG. 5). As described below, protocol instructions and data corresponding to one or more network protocols are downloaded from main processor 500 to network interface 170 for execution when main processor 500 is in the sleep state. By way of example only, the protocol instructions and data may define a routine for responding to data packets which are received during the sleep state of main processor 500 and which are in compliance with the selected network protocol. The data may include one or more request packet patterns and one or more reply packet patterns. Each packet pattern may define a complete packet or one or more fields of a packet. The database of protocol information in system memory 130 may include protocol information for one or more network protocols.

The database of protocol information can be built by the user or can be supplied as part of the initial configuration of the computing device. The database can be updated to add or delete network protocol information. Protocol information for newly-developed network protocols can be added. The data of the protocol information can be updated from time to time to reflect current conditions. Typically, the database may include protocol information corresponding to a number of network protocols that are likely to be used in a particular application.

In act 602, a network protocol is selected for operation. The network protocol is selected from the database of protocol information that was built in act 600. In act 604, protocol information relating to the selected network protocol is downloaded from main processor 500 to network interface 170. In particular, the protocol instructions and data are downloaded from system memory 130 to NIC memory 512. The downloading of protocol information to network interface 170 establishes a protocol mode that can be enabled when main processor 500 enters the sleep state. It will be understood that the selection of a network protocol and downloading of the protocol instructions and data corresponding to the selected network protocol can be repeated for any desired number of network protocols, within the capacity of NIC memory 512. Furthermore, protocol information corresponding to any network protocols that are no longer needed can be deleted from network interface 170 in act 606.

The acts of building a database of protocol information, selecting a network protocol for operation, downloading the selected network protocol to the network interface and deleting any undesired network protocol from the network interface can be performed at any time when the main processor 500 is active. These acts may be performed during initial configuration of the computing device or following any configuration change. In any event, these acts are performed before the computing device enters the sleep state.

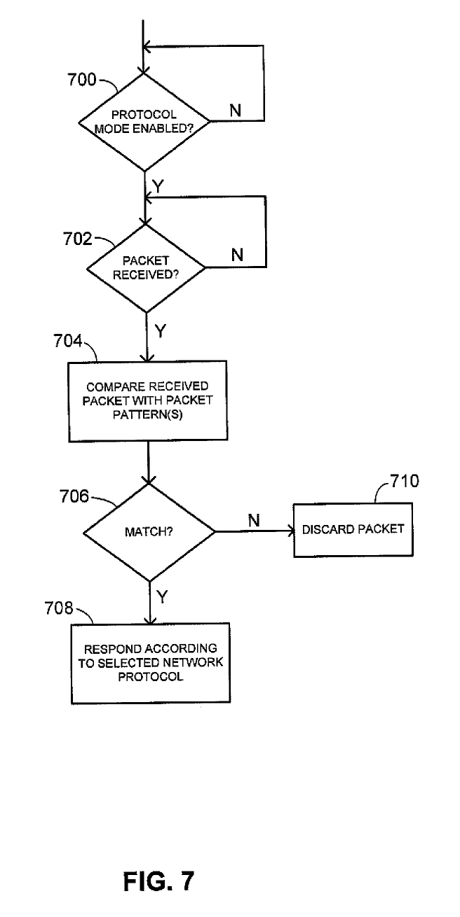

Referring again to FIG. 6, a determination is made in act 610 as to whether the main processor 500 has entered the sleep state. If the main processor 500 has not entered the sleep state, no action is taken and the protocol mode of the network interface 170 remains disabled. When the main processor 500 enters the sleep state, the protocol mode of network interface 170 is enabled in act 612. The network interface performs network protocol operations as described below in connection with FIG. 7. In act 614, a determination is made as to whether the main processor 500 has exited the sleep state. If the main processor 500 has not exited the sleep state, the network interface remains in the protocol mode and continues to perform network protocol operations. When the main processor 500 exits the sleep state, the protocol mode of the network interface is disabled in act 616. The process returns to act 610, and the protocol mode of the network interface remains disabled until main processor 500 again enters the sleep state.

A flow chart of operations performed by network interface 170 in accordance with embodiments of the invention as shown in FIG. 7. It is assumed that protocol instructions and data for one or more network protocols have been downloaded from main processor 500 to network interface 170 and that the protocol instructions are ready for execution. In act 700, a determination is made as to whether the protocol mode is enabled. As described above, the protocol mode is enabled by main processor 500 when main processor 500 enters the sleep state. By way of example only, main processor 500 may set a bit in a register of network interface 170 which indicates that the main processor 500 is in the sleep state. When the protocol mode is not enabled, network interface 170 takes no action with respect to network protocol operations. When the protocol mode is enabled, network interface 170 determines whether a data packet such as a request packet has been received in act 702. If a data packet is not received, no action is taken. When a data packet is received by network interface 170, the received data packet is compared with one or more received packet patterns in act 704. As indicated above, the packet pattern may define a complete packet or one or more fields of a packet for matching with a received packet. If the received packet is determined in act 706 to match a received packet pattern, the network interface responds according to the selected network protocol in act 708. If the received packet does not match one of the received packet patterns, the received packet is discarded in act 710.

By way of example, the response to the received packet may include sending one or more reply packets to the sender of the received packet, or sending no reply. In some embodiments, the reply packet is a fixed reply packet that is specified as a response to the received packet. In other embodiments, the content of the reply packet is constructed in accordance with the protocol instructions. For example, the address of the sender of the received packet may be inserted into the reply packet. The response may include a single reply packet or two or more reply packets. The number of reply packets and the content of each reply packet may vary according to the content of the received packet. In further embodiments, network interface 170 may respond to a received packet by sending a wakeup message to the main processor 500. It will be understood that the responses described above are given by way of example only and are not limiting as to the scope of the present invention. Furthermore, the network protocol may specify any combination of responses, such as sending a reply packet to the sender of the received packet and sending a wakeup message to the main processor 500. In further embodiments, network interface 170 may send a pre-programmed packet at programmed intervals.

It should be apparent from the above description that the present invention provides generic offloading of network protocol operations from the main processor to the network interface. The operating system of the main processor programs the network interface to respond to specific requests in specific ways at different times. The network interface can be programmed to recognize an entire incoming packet or only specific fields in the packet. For example, by pattern matching the entire packet, an ARP offload can be implemented. In this case, the operating system sends two buffers to the network interface when the main processor enters the sleep state. A first buffer contains an ARP request packet, and the second buffer contains an ARP reply packet. When the network interface receives a packet that matches the first buffer, it responds with the packet in the second buffer. Similarly, recognizing only specific fields of the packet can be used to implement IPv6 related protocols. Since IPv6 packets may contain variable size fields that would prohibit matching entire packets, matching only the sender, the receiver, the protocol, and the next header fields, stored in buffers downloaded by the operating system, allows implementation, for example, of Neighbor Solicitation as part of Neighbor Discovery for IPv6, where a positive match with specific fields of the Neighbor Solicitation triggers in return a buffer containing a Neighbor Advertisement packet.

Generic protocol offload allows the operating system to maintain control over which network protocols the network interface supports at any given time and takes the burden of insuring protocol compliance off the network interface. By offloading the protocol operations in a simplified manner, for example, for every packet A matching a certain set of criteria, reply with packet B, the operating system reduces processing by the network interface. Since the main processor has much more processing power then the network interface, insuring protocol compliance, programming the appropriate packets and maintaining the intelligence in the operating system helps to decrease power consumption by the network interface. The network interface is “agnostic” in the sense that it does not have any hard coded knowledge of network protocols. Instead, appropriate network protocol instructions and data are downloaded from the main processor to the network interface for execution when the main processor is in the sleep state.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method to enable a computing device to participate in network protocol operations when the computing device is in an inactive state, comprising:
a main processor of the computing device transferring protocol mode instructions and data corresponding to a selected network protocol to a network interface of the computing device; and
the network interface executing the protocol mode instructions on behalf of the main processor when the main processor is in the inactive state.

2. A method as defined in claim 1, further comprising:
the main processor enabling a protocol mode of the network interface when the main processor enters the inactive state; and
the main processor disabling the protocol mode of the network interface when the main processor exits the inactive state.

3. A method as defined in claim 1, wherein the data transferred from the main processor to the network interface includes at least one received packet pattern that complies with the selected network protocol.

4. A method as defined in claim 3, further comprising the network interface comparing a received packet to the at least one received packet pattern and responding to the received packet in accordance with a result of the comparison.

5. A method as defined in claim 4, wherein the data transferred from the main processor to the network interface includes a reply packet pattern that complies with the specified network protocol and wherein executing the protocol mode instructions comprises sending a reply packet having the reply packet pattern in response to a received packet.

6. A method as defined in claim 1, wherein transferring protocol mode instructions and data comprises downloading protocol mode instructions and data for different network protocols.

7. A method as defined in claim 1, wherein executing the protocol mode instructions comprises building a reply packet in response to a received packet that complies with the selected network protocol and sending the reply packet.

8. A method as defined in claim 1, wherein executing the protocol mode instructions comprises sending a fixed reply packet in response to a received packet that complies with the selected network protocol.

9. A method as defined in claim 1, wherein executing the protocol mode instructions comprises sending a pre-programmed packet at programmed intervals.

10. A method as defined in claim 1, wherein transferring protocol mode instructions and data comprises selecting a network protocol from two or more network protocols and downloading protocol mode instructions and data corresponding to the selected network protocol.

11. A method as defined in claim 4, wherein responding to the received packet comprises sending a message to the main processor.

12. A computer-readable storage medium encoded with instructions for execution in a computing device, the instructions when executed performing a method as defined in claim 1.

13. A computing device having an active state and an inactive state, comprising:
a main processor including a main processing device and a system memory, the system memory containing protocol mode instructions and data corresponding to at least one network protocol; and
a network interface including a network interface processing device and a network interface memory, wherein the main processor is configured to transfer the protocol mode instructions and the data corresponding to a selected network protocol from the system memory to the network interface memory and wherein the network interface is configured to execute the protocol mode instructions on behalf of the main processor when the main processor is in the inactive state.

14. A computing device as defined in claim 13, wherein the main processor is configured to enable a protocol mode of the network interface when the main processor enters the inactive state and is configured to disable the protocol mode of the network interface when the main processor exits the inactive state.

15. A computing device as defined in claim 13, wherein the network interface is configured to compare a received packet to at least one received packet pattern and to respond to the received packet in accordance with a result of the comparison.

16. A computing device as defined in claim 13, wherein the network interface is configured to build a reply packet in response to a received packet that complies with the selected network protocol and to send the reply packet.

17. A computing device as defined in claim 13, wherein the network interface is configured to send a fixed reply packet in response to a received packet that complies with the selected network protocol.

18. A computing device as defined in claim 13, wherein the network interface is configured to send a message to the main processor in response to a received packet that complies with the selected network protocol.

19. A computing device as defined in claim 13, wherein the main processor is configured to select a network protocol from two or more network protocols in the main memory and to download protocol mode instructions and data corresponding to the selected network protocol to the network interface.

20. A method to enable a computing device to participate in network protocol operations when the computing device is in an inactive state, comprising:
a main processor of the computing device selecting a network protocol from two or more network protocols;
the main processor transferring protocol mode instructions and data corresponding to the selected network protocol to a network interface of the computing device;
the main processor enabling a protocol mode of the network interface when the main processor enters the inactive state;
the network interface executing the protocol mode instructions when the main processor is in the inactive state by comparing a received packet to at least one received packet pattern and responding to the received packet in accordance with a result of the comparison.
